(19) United States
(12) Patent Application Publication
(10) Pub. No.: US 2016/0116718 A1
(43) Pub. Date: Apr. 28, 2016

(54) Methods and System for Manufacturing Infrared (IR) Absorbing Lens

(71) Applicant: Roger Wen Yi Hsu, Rancho Cucamonga, CA (US)

(72) Inventor: Roger Wen Yi Hsu, Rancho Cucamonga, CA (US)

(21) Appl. No.: 14/521,430

(22) Filed: Oct. 22, 2014

(51) Int. Cl. G02B 13/14; G02B 5/20; G02B 1/14; G02B 5/22

(52) U.S. Cl. CPC G02B 13/14; G02B 5/22; G02B 5/208; G02B 1/14

(57) ABSTRACT

A method to manufacture infrared lens comprising the steps of: providing a portion of polyurethane (PU) material; mixing a portion of OH compound into said PU material to form a portion of OH PU material; providing a portion of solvent and mixing said OH PU material to said solvent to form a portion of PU solution; providing a portion of IR dye and mixing said IR dye to said PU solution to form a portion of IR PU solution; providing a portion of catalyst and mixing said catalyst to a portion of NCO compound to form a portion of NCO catalyst; mixing said NCO catalyst to said IR PU solution to form a portion of IR PU liquid solution; applying said IR PU liquid solution to a lens layer; allowing said PU liquid solution to solidify to form a IR functional lens layer.

### INCORPORATION BY REFERENCE

This application claims the benefit of priority under 35 U.S.C. 119(e) to the filing date of U.S. provisional patent application No. 62/025,183 “Methods and System for Manufacturing Infrared (IR) Lens” which was filed on Jul. 16, 2014, and which are incorporated herein by reference in their entirety.

### FIELD OF THE INVENTION

The present invention relates generally to an optical component, and more particularly it is directed to method and system of coating and producing infrared (IR) absorbing lens.

### BACKGROUND OF THE INVENTION

Infrared (IR) is invisible radiant energy. It is electromagnetic radiation with electromagnetic spectrum extending from wavelengths of approximately 0.7 μm to 1000 μm, which is between the upper limit of the visible radiation region and the lower limit of the microwave region. Most of the thermal radiation emitted by object near room temperature is infrared.

Infrared is everywhere. For example, wireless communication, appliances, computer, and lights all emit different levels of harmful radiation. In fact, there are also plenty of natural infrared, such as those from sunlight. Sunlight is composed of thermal-spectrum radiation that is slightly more than half infrared. At zenith, sunlight provides an irradiance of approximately 1 kilowatt per square meter at sea level, of which 527 watts is infrared radiation. Once the sunlight reaches the surface of Earth, almost all thermal radiation are of infrared.

The energy of sunlight on the ground can be categorized into approximately 3% Ultraviolet (UV) rays, 44% visible rays, and 53% Infrared (IR) rays. Currently, there are no high quality lenses for blocking or shielding IR ray. If lenses are coated to block out IR rays in addition to blocking out UV rays, it would reduce or mitigate eye diseases such as cataract and glaucoma.

People see things and landscapes around the range of 550 nm green-yellow zone. However, the 780 nm-2000 nm infrared ray interference causes imbalance in the green zone. This makes it more difficult to focus, as it wastes energy and causes fatigue.

In the printing market, a select few products have anti-IR lenses. The effects of these anti-IR lenses, however, is limited. For example:
a. Vacuum plating colored film on the outside of the convex lens (US20130235452 U.S. Pat. No. 7,066,596 US20130278893).
   The problem with these anti-IR lenses is that they are easily scratched and the reflections are too bright. In fact, the more the lenses reflect, the less clarity the lenses provide.
b. IR-absorbing Dye mixed with other materials: windows and automotive windows with an outer layer thickness of 0.8-1.5 mm (EP0989419 U.S. Pat. No. 7,957,077 U.S. Pat. No. 8,441,724 U.S. Pat. No. 6,893,689); IR absorber mixed with glass material (US20080186565 EP2402794).
   The problem with these anti-IR lenses is that the process requires the injection or extrusion materials to be processed at temperatures above 200 degrees Celsius. Therefore, the high temperature causes parts of the IR-absorbing Dye to be damaged or degraded. Alternatively, IR-absorbing Dye that can withstand higher temperature will result in lower clarity of lenses. Furthermore, IR-absorbing Dye cannot be packed densely on a thin surface, and IR-absorving Dye will disperse on a thick surface. Therefore, they will be ineffective and will cause discomfort to the user.
c. Liquid coating composition that absorb near infrared electromagnetic radiation (U.S. Pat. No. 6,794,431).
   The problem with these anti-IR lenses liquid is that they are limited to formulas that include IR-absorbing agent. It provides roughly uniform coating, it is inexpensive, and it provides a certain shelf life. However, the formula provides only a superficial layer, and the layer is not resistant to chemical solvents. As such, the layer will be prone to erosion and lose its functionality as a result. Therefore, the process is not suitable for laminating, strengthening, or protecting the surface, nor does it reach the required level of optical quality. In addition, the carrier needs three or more polymer mixed according to specific proportion with polymerization process to produce the IR absorbing layer.
   In patent PCT/US2008/073863, the problem with these anti-IR lenses liquid is that they are limited to formulas that include IR-absorbing agent. The carrier that used required at least three kind of polymer, with specific proportion using polymerization process to form the layer.
   Both U.S. Pat. No. 6,794,431 and PCT/US2008/073863 patents dealt with coating surface, but our liquid coating composition is only one component of all layers for eye wears; in addition the prior invention is for automobile glasses and license plate surface. Their invention of the liquid coating composition, although inexpensive did not reach the optical quality.
d. Heat-absorbent multi-layer structure (U.S. Pat. No. 6,893,689 and U.S. Pat. No. 6,780,515).
   While the above both uses IR-absorbing dye, the process is different because the disposition of the layers (including IR absorbing dye) is different.

Generally, infrared radiation is sometimes broken into three sub-regions: near-infrared radiation with wavelengths between 0.7-1 μm, intermediate-infrared radiation with wavelengths between 1-20 μm, and far-infrared radiation with wavelengths between 20-1000 μm. The intermediate-infrared radiation region is often further broken into the short-wave (SWIR) region with wavelength limits of 1-3 μm, mid-wave (MWIR) region with wavelength limits of 3-5 μm, and the long-wave (LWIR) region with wavelength limits of 8-14 μm.

Infrared radiation is produced principally by electromagnetic emissions from solid materials as a result of thermal excitation. The detection of the presence, distribution, and direction of infrared radiation requires techniques which are unique to this spectral region. The wavelengths of infrared radiation are such that optical methods may be used to collect, filter, and direct the infrared radiation. Photosensitive devices convert heat, or infrared electromagnetic radiation, into electrical energy and are often used as infrared sensitive elements. Such photosensitive devices respond in proportion to the number of infrared photons within a certain range of wavelengths to provide electrical energy.

An infrared absorbing lens is transmissive to the wavelengths of radiation to be detected. Materials for a lens are wavelength matched to the desired spectrum coverage. Although suitable materials may be selected based on the range of IR wavelengths, other material characteristics can impact the manufacturing of IR absorbing lenses. For example, the optical characteristics of silicon are advantageous for use as the material for IR absorbing lenses. Silicon can be cut into the desired lens geometry, using, for example, a diamond tool to manufacture the surface. However, the hardness of silicon results in slow material removal and wears the diamond tool faster than other IR materials like germanium. In extreme cases, the cost of manufacturing silicon into IR absorbing lenses can negate the cost savings from the bulk material and cause optical materials used in the IR spectral range to be expensive and require expensive manufacturing processes.

Traditional methods of application of infrared dye onto lenses include the use of injection or extrusion of infrared dye onto the lenses. The high heat required in such traditional methods often degrades the integrity of the infrared dyes, and as a result reduces its effectiveness. Additionally, because the majority of lenses are curved, the curvature of the lenses presents a significant obstacle in the application of the infrared dye absorbed coating, as the application of the coating may be uneven. The uneven application of the infrared dye absorbed coating via injection or extrusion methods on a curved surface would reduce the effectiveness of the infrared absorbing, thus defeating the said coating's original purpose. Furthermore, traditional coating methods by injection or extrusion methods are aesthetically less appealing because infrared dye appears green in such a coating. In order to counteract or offset the undesirable green color, gray colors may be added to the PVA film. The addition of such gray colors, however, reduces the penetration of light, and therefore the visibility of the viewers, significantly. Finally, the addition of the gray colors to the PVA films on the lens results in higher costs for the lenses, and thus higher costs for the end products. Therefore, material and manufacturing processes for IR absorbing lenses that are inexpensive and quick are desirable.

### OBJECT OF THE INVENTION

Accordingly, it is the object of this invention to provide a method and system for infrared absorbing lenses.

It is also the object of the present invention to provide a method and system for infrared absorbing lenses, wherein the coating is thinner than that of traditional infrared absorbing coating for lenses.

It is also the object of the present invention to provide a method and system for infrared lenses, wherein the infrared lenses have high clarity, high color saturation, and low haziness.

The new invention provides a NIR absorbing layer on top or the under of substrate. In order to provide an optical quality lens, the hardness of the IR absorbing layer should be lower than 1.5 H (H was used as a unit for pencil hardness gage, H represents the hardness, the high the number the harder the material) in order to form a layer that later on can be combined with other layer to form a complete lens that is sturdy, transparent, no particles, and no bubbles can stand for scratching, washing, and could be used for at least three years.

It is an object of the present invention to provide a method of infrared absorbing dye absorbed coating layer application whereby the infrared absorbing coating can be applied by dipping or spraying, among other techniques.

It is an object of the present invention to provide a method to apply infrared absorbing dye to both plane/flat surfaces and on curved surfaces.

It is an object of the present invention to provide a method of controlling the degree of infrared absorbing via change in the amount of infrared dye powder in the solvent, whereby additional infrared dye powder can be added to increase the amount of infrared ray absorbing of the coating and vice versa.

It is an object of the present invention to provide a method of making an infrared dye absorbed coating with increased capability to absorbing infrared.

It is an object of the present invention to provide a method of making an infrared dye absorbing layer, wherein the said layer is aesthetically pleasing and does not distort the color of the coated lens.

It is an object of the present invention to provide a method of making an infrared absorbing coating layer, wherein a wider range of wave lengths can be absorbed with the same coating layer.

It is an object of the present invention to provide a method of making an infrared absorbing layer, wherein the layer allows for better light transmission thus providing better visibility.

It is an object of the present invention to provide a method of making an infrared absorbing layer that corrects the problem of traditional methods of coating including extrusion or injection, and avoids the method of using multi-layer vacuum coating.

It is another object of the present invention to provide a method of making an infrared absorbing layer, wherein different IR dye absorbing powder can absorb different wave length and the different IR dye absorbed powder can be mixed to absorb a wider range of wave length.

### SUMMARY OF INVENTION

In one aspect, a method to manufacture infrared lens is disclosed comprising the steps of: providing a portion of polyurethane (PU) material wherein the portion of polyurethane (PU) material is comprised of NCO (Cyanate) compound; providing a portion of IR dye and mixing the IR dye to the portion of polyurethane (PU) material to form a portion of IR PU solution; mixing a portion of catalyst wherein the catalyst is comprised of OH (Hydroxide) compound with the IR PU solution to form a portion of OH (Hydroxide) IR PU material; providing a portion of solvent and mixing the OH (Hydroxide) IR PU material to the solvent to form a portion of OH (Hydroxide) IR PU liquid solution; applying the OH (Hydroxide) IR PU liquid solution to a lens layer; allowing the OH (Hydroxide) IR PU liquid solution to solidify to form a IR functional lens layer. In one embodiment, the portion of polyurethane (PU) material is comprised of isocyanurate or polyisocyanate. In one embodiment, the invention further comprising the step of allowing the OH (Hydroxide) IR PU liquid solution to solidify between 4-8 hours.

In one embodiment, the step of allowing the OH (Hydroxide) IR PU liquid solution to solidify for 6 hours. In one embodiment, the ratio of the portion of solvent to the portion of polyurethane (PU) material is 2:1.

In one embodiment, the portion of IR dye is between 1-3% of the portion of IR PU solution. In one embodiment, the catalyst is selected from a group consisting of polyester polyol or hydroxyl-bearing polyacrylate. In one embodiment, the ratio of the NCO (Cyanate) compound to the OH (Hydroxide) compound is between 1:0.3 to 1:16. In one embodiment, the ratio of the NCO (Cyanate) compound to the OH (Hydroxide) compound is 1:5. In one embodiment, the IR functional lens layer is between 0.03-0.12 mm in thickness. In one embodiment, the solvent is selected from a group consisting of Tetrakis ammonium structure, Iminium phthalocyanines, naphthalocyanines, metal complexes, azo dyes, anthraquinones, quadratic acid derivatives, immonium dyes, perylenes Dianthrones Cyanines Heteroaromatics Metal Dithiolenes Oxadiazoles Phthalocyanines Spiropyra Tetraaryldiamines Triarylamines,

In one embodiment, the invention further comprising the step of applying a layer of isolation layer between the IR functional layer to the lens layer. In one embodiment, the isolation layer is selected from a group consisting of PU, acrylic, silicon and epoxy compounds. In one embodiment, the isolation layer is comprised of PU, acrylic, silicon and epoxy compounds. In one embodiment, the invention furthering comprising the step of applying a reinforcement layer between the IR functional lens layer and the lens layer. In one embodiment, the invention comprising the step of applying a reinforcement layer between the IR functional lens layer and the IR isolation layer. In one embodiment, the reinforcement layer is comprised of epoxy compound wherein the epoxy compound further comprises acrylic resin.

In one aspect of invention, an infrared absorbing lens apparatus is disclosed comprising: a base substrate; a IR functional lens layer wherein the IR functional lens layer comprises a portion of PU wherein the portion of PU further comprising a portion of NCO (Cyanate) compound, a portion of IR dye, and a portion of catalyst wherein the catalyst further comprising a portion of OH (Hydroxide) compound. In one embodiment, the apparatus further comprising a PVA film layer. In one embodiment, the apparatus further comprising an epoxy layer. In one embodiment, the apparatus further comprising a hard coating layer. In one embodiment, the apparatus further comprising a isolation layer. In one embodiment, the apparatus further comprising a reinforcement layer. In one embodiment, the reinforcement layer is comprised of PU, acrylic, silicon and epoxy compounds

In one aspect of the invention, a method to manufacture infra red absorbing lens is disclosed comprising: providing a portion of silicon material; providing a portion of solvent and mixing the portion of solvent to the portion of silicon material to form a portion of silicon solution; providing a portion of IR dye and mixing the portion of IR dye to the portion silicon solution to form a portion of IR silicon solution; providing a portion of acid to the portion of IR silicon solution to form a portion of acid IR silicon solution; applying the portion of acid IR silicon solution to a lens layer; heating the acid IR silicon solution to allowing the acid IR silicon solution to solidify to form a IR functional lens layer. In one embodiment, the ratio of the portion of acid to the portion of IR silicon solution is 1 to 500. In one embodiment, the invention further comprising heating the portion of acid IR silicon solution to 85-100 degree Celsius. In one embodiment, the invention further comprising heating the portion of IR silicon solution for 1-3 hours. In one embodiment, the thickness of the IR functional lens layer is between 0.03-0.12 mm. In one embodiment, the solvent is selected from a group consisting of Tetrakis ammonium structure, Iminium phthalocyanines, naphthalocyanines, metal complexes, azo dyes, anthraquinones, quadratic acid derivatives, immonium dyes, perylenes Dianthrones Cyanines Heteroaromatics Metal Dithiolenes Oxadiazoles Phthalocyanines Spiropyra Tetraaryldiamines Triarylamines. In one embodiment, the invention further comprising applying a layer of isolation layer between the IR functional lens layer to the lens layer. In one embodiment, the isolation layer is comprised of PU, acrylic, silicon, epoxy or similar material. In one embodiment, the invention is furthering applying a reinforcement layer between the IR functional lens layer and the lens layer. In one embodiment, the reinforcement layer is comprised of an epoxy compound wherein the epoxy ground comprises acrylic resin.

In one aspect of the invention, is disclosed wherein an IR lens apparatus comprising: a first layer of hard coating comprising a first surface and a second surface wherein the first surface of the first layer of hard coating is furthest away from a user; a second layer of hard coating comprising a first surface and a second surface wherein the 2nd hard coating second surface is closest to the user; a layer of IR isolation layer having a first surface and a second surface where the first surface of IR isolation layer is adjacent to the second surface of the first coating layer; an IR functional layer having a first surface and a second surface wherein the functional layer first surface is adjacent to the second surface of the IR isolation layer; a layer of PVA film comprising a first surface and a second surface wherein the first surface of the PVA film layer adjacent to the second surface of the IR functional layer; a layer of epoxy comprising a first surface and a second surface wherein the first surface of the epoxy layer is adjacent to the second surface of PVA film layer; a base lens layer comprising a first surface and a second surface wherein the first surface of the base lens layer adjacent to the second surface of the epoxy layer; and the first surface of the second hard coating is adjacent to the second surface of the base lens layer.

In one aspect of the invention, An IR lens apparatus comprising: a first layer of hard coating comprising a first surface and a second surface wherein the first surface of the first layer of hard coating is furthest away from a user; a second layer of hard coating comprising a first surface and a second surface wherein the 2nd hard coating second surface is closest to the user; a first layer of epoxy comprising a first surface and a second surface wherein the first surface of the first layer of epoxy is adjacent to the second surface of the first layer of coating; a layer of IR isolation layer having a first surface and a second surface where the first surface of IR isolation layer is adjacent to the second surface of the first epoxy layer; an IR functional layer having a first surface and a second surface wherein the functional layer first surface is adjacent to the second surface of the IR isolation layer; a layer of PVA film comprising a first surface and a second surface wherein the first surface of the PVA film layer adjacent to the second surface of the IR functional layer; a layer of second epoxy comprising a first surface and a second surface wherein the first surface of the second epoxy layer is adjacent to the second surface of PVA film layer; a base lens layer comprising a first surface and a second surface wherein the first surface of the base lens layer adjacent to the second surface of the epoxy layer; and the first surface of the second hard coating is adjacent to the second surface of the base lens layer.

In one other aspect of the invention; an IR lens apparatus is disclosed comprising: a first layer of hard coating comprising a first surface and a second surface wherein the first surface of the first layer of hard coating is furthest away from a user; a second layer of hard coating comprising a first surface and a second surface wherein the 2nd hard coating second surface is closest to the user; a layer of epoxy comprising a first surface and a second surface wherein the first surface of the layer of epoxy is adjacent to the second surface of the first layer of coating; a layer of IR reinforcement layer having a first surface and a second surface where the first surface of IR reinforcement layer is adjacent to the second surface of the epoxy layer; a layer of IR isolation layer having a first surface and a second surface where the first surface of IR isolation layer is adjacent to the second surface of the reinforcement layer; a first IR functional layer having a first surface and a second surface wherein the first functional layer first surface is adjacent to the second surface of the IR isolation layer; a layer of PVA film comprising a first surface and a second surface wherein the first surface of the PVA film layer adjacent to the second surface of the IR functional layer; a layer of second IR functional layer comprising a first surface and a second surface wherein the first surface of the second IR functional layer is adjacent to the second surface of the PVA film layer; a base lens layer comprising a first surface and a second surface wherein the first surface of the base lens layer adjacent to the second surface of the epoxy layer; and the first surface of the second hard coating is adjacent to the second surface of the base lens layer.

In other aspect of the invention, an IR lens apparatus is disclosed comprising: a first layer of hard coating comprising a first surface and a second surface wherein the first surface of the first layer of hard coating is furthest away from a user; a second layer of hard coating comprising a first surface and a second surface wherein the 2nd hard coating second surface is closest to the user; a layer of first epoxy comprising a first surface and a second surface wherein the first surface of the layer of first epoxy is adjacent to the second surface of the first layer of coating; a layer of IR isolation layer having a first surface and a second surface where the first surface of IR isolation layer is adjacent to the second surface of the first epoxy layer; a first IR functional layer having a first surface and a second surface wherein the first functional layer first surface is adjacent to the second surface of the IR isolation layer; a layer of second epoxy comprising a first surface and a second surface wherein the first surface of the second epoxy layer adjacent to the second surface of the IR functional layer; a base lens layer comprising a first surface and a second surface wherein the first surface of the base lens layer adjacent to the second surface of the second epoxy layer; and the first surface of the second hard coating is adjacent to the second surface of the base lens layer.

### BRIEF DESCRIPTION OF THE DRAWINGS

These and other features and advantages of the invention will not be described with reference to the drawings of certain preferred embodiments, which are intended to illustrate and not to limit the invention, and in which

FIG. 1 is an illustrative view of the preparation of the solute being dissolved in the solvent.

FIG. 2. is an illustrative view of the preparation of IR dye being dissolved in the mixture.

FIG. 3 is an illustrative view of the preparation of the PVA film being treated with the IR dye liquid.

FIG. 4 is an illustrative view of an alternative method of preparation of the PVA film being coated with the mixture.

FIG. 5 is an illustrative view of the application of the IR absorbing layer on a curved surface of a lens.

FIG. 6 is an illustrative view of a curved lens with an IR absorbing layer applied within the lens.

FIG. 7 is a diagram of the casting method.

FIG. 8 is a diagram of the O-ring controller for a mold.

FIG. 9 is a continuation of the above diagram.

FIG. 10 is a continuation of the sequential steps of the above diagram.

FIG. 11 is a diagram of the supporter.

FIG. 12 is a diagram of the next step of the procedure involving the supporter.

FIG. 13 is a diagram of procedural steps in the rim-lock method with epoxy drops.

FIG. 14 is a diagram of e next step of the rim-lock method.

FIG. 15 is a diagram of the next step of the rim-lock method.

FIG. 16 is the rim-lock method with epoxy injection procedural diagram.

FIG. 17 depicts one embodiment of the cross-sectional view of a layered lens produced by the present claimed methods.

FIG. 18 depicts one embodiment of the cross-sectional view of a layered lens produced by the present claimed methods.

FIG. 19 depicts one embodiment of the cross-sectional view of a layered lens produced by the present claimed methods.

FIG. 20 depicts one embodiment of the cross-sectional view of a layered lens produced by the present claimed methods.

### DETAILED DESCRIPTION OF THE INVENTION

Some embodiments are described in detail with reference to the related drawings. Additional embodiments, features, and/or advantages will become apparent from the ensuing description or may be learned by practicing the invention. The following description is not to be taken in a limiting sense, but is made merely for the purpose of describing the general principles of the invention. The steps described herein for performing methods form one embodiment of the invention, and, unless otherwise indicated, not all of the steps must necessarily be performed to practice the invention, nor must the steps necessarily be performed in the order listed. It should be noted that references to “an” or “one” or “some” embodiment(s) in this disclosure are not necessarily to the same embodiment, and such references mean at least one.

In accordance with the practice of the present invention, the IR absorbing lens disclosed herein provides many important advantages over those of the prior art. Specifically, the IR absorbing lens can absorb infrared while maintaining high clarity, high color saturation, and low haziness.

Particularly, the IR absorbing lens protects the eyes of the user from eye injury as a result of absorbing various lights harmful to the eyes—including but not limited to infrared light in the 780 nm-2000 nm and UV ABC 100 nm-400 nm spectrum. In fact, even visible light in the 380 nm-780 nm should be selectively absorbed as according to need. The manufacturing of the lens uses a thin 0.003 mm-0.15 mm oil-bone Liquid composition to make a thin film or multi-layered film.

These densely packed IR functional layer is formed by having the Liquid composition applied on top, below, or between a non-polarized lens or a polarized lens, which contains a PVA film. For the non-polarized lens (without PVA film), the lens surface has had surface treatment and the Liquid composition can be disposed on the surface using various methods. Furthermore, UV absorb dye can be applied to absorb ultraviolet light, and visible absorb dye can absorb visible light. These functional layer or layers do not erode as it is resistant to chemical solvents. Therefore, in the process of making or coating, the layer will not be diluted or destroyed, and it is able to maintain its function. The invention can be practiced in two ways:
1. Chemical solvent functional layer is formed with solute being that is mixed with PU material containing polyisocyanate or isocyanurate which contains molecules NCO (Cyanate) and with catalyst that contains molecules OH (Hydroxide) to form a chemical bond. Furthermore, in order to strengthen its protection, additional layers of isolation layer and or a reinforcing layer, or two layers may be applied.
2. The Silicon acidic solvent mixture is added and heat of about 80-100 degrees Celsius is applied to allow the acidic solvent to mix with the Silicon in a chemical reaction that forms a hardened layer, wherein additional layers, reinforcing layers, or two layers may be applied.

The above procedure can be applied to lens or the PVA lens or non-PVA lens. After completion of the functional layer, the layer can be bent through injection into the a cast or through the use of casting.

The invention disclosed herein can be used in sun glasses or optical film. It can also be widely used in electronic display, architectural windows, car windows, car panels, mobile phone panels, telescope, aerospace science, camera optical lens films, TV screens or TV protection screen, and lighting lamp housing.

I. Infrared (IR) Absorbing Lens for Use as Sunglasses Lens, Optical or Light Color Lens, and Optical Blue Blocker Lens

The infrared (IR) absorbing lenses disclosed herein is composed of a liquid composition that includes polyurethane (PU)-like resin with solvent to dissolve and dilute the IR absorbing dye. IR absorbing dye is an organic dye material. Suitable solvents for the IR absorbing dye may include materials such as Tetrakis ammonium structure, Iminium phthalocyanines, naphthalocyanines, metal complexes, azo dyes, anthraquinones, quadratic acid derivatives, immonium dyes, perylenes Dianthrones Cyanines Heteroaromatics Metal Dithiolenes Oxadiazoles Phthalocyanines Spiropyra Tetraaryldiamines Triarylamines, etc.

The polyurethanes polymer liquid contains polyisocyanate or isocyanurate having NCO (Cyanate) molecules mixed with having OH (Hydroxide) molecules forming a chemical resistant bond. This will provide a thickness of only 0.03-0.12 mm at its most densely packed IR-absorbing functional layer. Furthermore, because of it's chemical resistance property, in the process of adhesion or bonding, the layer will not erode. Moreover, anti-UV, visible light absorbing, and pH buffer modifying material can be added to the top or bottom of the IR-absorbing dye functional layer. Finally, liquid coating isolating layer, cover layer, or reinforcing layer can also be added. IR lenses manufactured or made according to the method and system provided herein can be used in various applications, including but not limited to sunglasses lens, optical lens or light color lens, and optical blue blocker lens.

A. Sunglasses Lens

The human eye locks on to the green zone around the range of 550 nm when it initially sees things or landscape. However, the 780 nm-2000 nm infrared ray interference causes imbalance in the green zone. As a result of the imbalance of the green zone, the eyes have more difficulty focusing, wasting energy and causing fatigue.

In order to protect the eyes, a functional layer is added to lenses. The functional layer plays an important role in lowering temperature through absorbing the heat generated by infrared. This can reduce the damages to eyes, and reduce interference and scattering. Optionally, visible light absorbing material and UV light absorbing material can also be added.

For IR absorbing lens for use with sunglasses, the IR absorbing lens can absorb over 70% of the infrared in the 780 nm-1300 nm wavelength range, and absorb over 30% of the infrared in the 1300 m, −2000 nm wavelength range. The IR dye will weigh about 1-3% of the total weight of the liquid.

Furthermore, with the addition of visible light absorbing dye (part of which is the dye color of the IR) on the lens, the substrate lens, in the materials, or in any layers, the lenses can absorbed over 70% of visible light in the 400 nm-780 nm wavelength.

Moreover, with the addition of UV absorbing dye in the functional layer, in the glue, on the surface of the substrate lens, in the materials, or in any of the layers, the lens can absorb over 95% of UV A, B, and C in the 100 nm-400 nm wavelength.

B. Optical Lens or Light Color Lens

For optical lens or light color lens, the IR absorbing lens can absorb over 60% of the infrared in the 780 nm-1300 nm wavelength range, and absorb over 20% of the infrared in the 1300 nm-2000 nm wavelength range. The IR absorbing dye will weigh about 1-2.5% of the total weight of the liquid. This is because IR dye itself already has color, therefore, IR dye concentration in optical lens and light color lens need to be reduce to prevent the lens from becoming too tinted for its intended purposes.

Furthermore, with the addition of visible light absorbing dye (part of which is the dye color of the IR) on the lens, the substrate lens, in the materials, or in any layers, the lens can absorbed over 20% of visible light in the 400 nm-780 nm wavelength. Also, with the addition of visible light absorbing dye (part of which is the dye color of the IR) on the functional layer, in the glue, on the surface of the lens, in the material, or in any layer, the lens can absorbed over 25% of visible light in the 550 nm-600 nm wavelength.

Moreover, with the addition of UV absorbing dye in the functional layer, in the glue, in the surface of the substrate lens, in the materials, or in any of the layers, the lens can absorb over 95% of UV A, B, C in the 100 nm-400 nm wavelength.

C. Optical Blue Blocker Lens

Blue light has a very short wavelength and is detectable by the human eye. In fact, blue light accounts for approximately 50% of visible light. The plethora of electronic devices in use today, such as cellular phones, tablets, and laptop computers, has drastically increased people's exposure to blue light. Furthermore, computer monitor, light, mobile phone, tablet, wi-fi, communication, electrical appliances will scatter UV in the 380 nm-460 nm wavelength or even stronger blue light, as well as yellow-green light in the in the 550 nm-500 nm wavelength. Increase exposure to large amounts of blue light can be harmful to the eyes. This is because blue light may cause oxidative damage to the eyes, and may play an integral role in causing age-related macular degeneration, which can lead to significant vision loss. Therefore, lens that can protect the eyes from blue lights, or optical blue blocker lens, is necessary.

For optical blue blocker lens, the lens can absorb over 60% of the infrared in the 780 nm-1300 nm wavelength range, and absorb over 20% of the infrared in the 1300 m, −2000 nm wavelength range. The IR absorbing dye will weigh about 1-2.5% of the total weight of the liquid. This is because the IR dye itself has color, therefore, IR dye concentration in optical lens and light color lens needs to be reduce.

Furthermore, with the addition of visible light absorbing dye (part of which is the dye color of the IR) in the functional layer, in the glue, on the surface of the substrate lens, in the material, or any layers, the lens can absorbed over 35% of visible light in the 400 nm-460 nm wavelength. Also, the addition of visible light absorbing dye (part of which is the dye color of the IR) on the functional layer, in the glue, on the surface of the lens, in the material, or in any layer, the lens can absorbed over 25% of visible light in the 550 nm-600 nm wavelength.

Moreover, with the addition of UV absorbing dye in the functional layer, in the glue, on the surface of the substrate lens, in the materials, or in any of the layers, the lens can absorb over 95% of UV A, B, and C in the 100 nm-400 nm wavelength.

II. Components of an IR Absorbing Lens

Generally, the IR absorbing lens is composed of the functional layer, glue layer, liquid composition layer, substrate layer, epoxy layer, and the hard coating layer.

A. IR Functional Layer with PU

The functional layer is formed first by forming IR liquid composition by mixing solute Polyurethane (PU) containing polyisocyanate (or isocyanurate) having NCO (Cyanate) molecules and mixing it with solvent. Solvent can be any of the listed here in: Acetone Benzene Cyclohexanone Ethanol Methanol MEK Alcohols Ketones Ethanol N-methylpyrrolidone (NMP) Chlorofor DMF Dioxane Ethyl Acetate Methylene Chlorid Methyl Ethyl Ketone Octane. In a prefer embodiment, the ideal mixing ration should be 60-70% solvent and 30%-40% PU.

Once mixed, a portion of IR absorbed dye is added to the mixture and mixed thoroughly. IR dye can be of Tetrankis ammonium structure or Iminium phthalocyanines, naphthalocyanines, metal complexes, azo dyes, anthraquinones, quadratic acid derivatives, immonium dyes, perylenes Dianthrones Cyanines Heteroaromatics Metal Dithiolenes Oxadiazoles Phthalocyanines Spiropyra Tetraaryldiamines Triarylamines.

A catalyst is then added to the solution. Generally the catalyst is comprised of polyester polyol or hydroxyl-bearing polyacrylate. Specifically, the catalyst would need to include a portion of OH (Hydroxide). Once the catalyst is added to the solution, NCO (Cyanate) molecules in PU will react with OH (Hydroxide) in the catalyst and cause the solution to solidify overtime. This IR liquid composition thereby can be applied to various substrate surfaces and forms the IR functional layer of a lens.

In one embodiment, ultra violet light absorber dye can be added to the mixture as well as color dye can be added to the mixture. Generally the ratio of NCO (Cyanate) to OH (Hydroxide) should be between 1:0.3 to 1:16 in the context of NCO(Cyanate):OH(Hydroxide).

IR functional layer can be applied on any lens at any place with any shape. For example, the functional layer can be applied on the following:
on a flat surface
on the top or bottom of a layer
on both sides or in between the layers
on the convex side or the middle of a casting lens
on above, below, or between a polarized or non-polarized lens
on above, below, or between an optical lens
on above, below, between or in any one or two layers of a contact lens
on one or more layers of a computer screen or on any layer of the outer protective screen
on above, below, or between a electronic communication lens, a camera lens, or an optical lens
in the middle or on either side of an automotive glass or architectural glass.

B. IR Functional Layer with Silicon

In the alternative, the IR liquid composition is made by adding apportion of silicon polymer mixing with solvent. In the process, a portion of IR absorber dye is added to the mixture. The IR absorber dye can be organic dye such as Tetrankis ammonium structure or Iminium phthalocyanines, naphthalocyanines, metal complexes, azo dyes, anthraquinones, quadratic acid derivatives, immonium dyes, perylenes Dianthrones Cyanines Heteroaromatics Metal Dithiolenes Oxadiazoles Phthalocyanines Spiropyra Tetraaryldiamines Triarylamines. The solvent can be Acetone, Benzene, Cyclohexanone, Ethanol Methanol, MEK Alcohols, Ketones Ethanol, N-methylpyrrolidone (NMP), Chlorofor, DMF Dioxane, Ethyl Acetate, Methylene Chlorid, Methyl Ethyl, Ketone, Octane and Alcohol.

Thereafter, a portion of Acid is added to the mixture. At this point, without heating the acid in the mixture, solidification will not take place. When ready, the mixture is next heated to 85-100 degree Celsius for 1-3 hours which will induce the solidification of the mixture to eventually for the IR functional layer. The ideal thickness of the IR functional layer can be anywhere between 0.03 to 0.12 mm. Generally the amount of acid as a percentage to the mixture is 0.20%. In one embodiment, ultra violet light absorber dye can be added to the mixture as well as color dye can be added to the mixture.

C. Isolation Layer

Furthermore, in order to strengthen the integrity and finish of the IR functional layer, a layer of isolation can be optionally applied. In a prefer embodiment, the IR isolation layer can be applied either on top of the IR functional layer or it be applied to the bottom of the IR functional layer. In another embodiment, it can be applied to both the top and the bottom of the IR functional layer. It is better to add isolation layer, it can protect the absorbing power of IR absorbing layer. Without the IR isolation layer, the IR functional layer can have visible micro residue and is likely to degrade under the Sun. An IR isolation layer can be made with PU, acrylic, silicon, epoxy or similar material.

D. Reinforcement Layer

In addition, a IR reinforcement layer can be added to the IR functional layer and the IR isolation layer. A IR reinforcement layer is made with materials comprising epoxy compounds further comprising acrylic resin. IR reinforcement layer can be applied to top of bottom of IR functional layer or top of bottom of the isolation layer as stated above.

E. Substrate Matrix

It should be noted that the substrate can be selected from PC, Acrylic, PU, Glass, Nylon, or CR 39 or high index lens material. In yet another embodiment, the substrate lens can have a gradient color.

III. Methods to Dispose Liquid Composition on Substrate

In one embodiment, the liquid composition dispose on substrate through the method of dipping, flowing, spraying, spinning, or impressing or casting mold.

The process may be applied to substrate lens on the concave or convex side through vacuum coating. The process can also be applied to multilayer lens. (liquid polymer) includes, but is not limited to, polyurethane, silicon, epoxy, etc.

IV. Inorganic Luminophore

luminophore is an atom or atomic grouping or compounds that manifests luminescence, which is the emission of light not resulting from heat. Luminophore is a form of cold body radiation. Luminophores can also be divided into organic and inorganic luminophores.

As the title of this section suggests, inorganic luminophores with near infrared or visible emission may be added to the lens as well. The inorganic luminophores can be added on any layer such as the glue layer, IR liquid composition layer, substrate layer, epoxy layer, or the hard coating layer.

V. Processes for Manufacturing IR Absorbing Lens

The manufacturing IR absorbing lens can be categorized into three types of processes: (A) non-polarized lens or polymer sheet; (B) Polarized plastic curved lens or flat sheet; (C) polarized curved glass lens or flat glass lens.

Notably, in the manufacturing processes for both the non-polarized and polarized lens, the layer can be applied in different locations or positions. Furthermore, the primer may be directly mixed with the near infrared (NIR) dye liquid composition having chemical resistance and/or mix with visible dye and/or UV dye. This will result in one less step in the manufacturing process.

A. Non-Polarized Lens or Polymer Sheet

First, inspect the curved lens or substrate polymer sheet. Second, etch the curved lens or substrate polymer sheet. Third, hold the curved lens or substrate polymer sheet in fixture. Fourth, spin to coat the primer. Fifth, Spin or dip the lens in order to apply one or more layers of near infrared (NIR) dye liquid composition. Alternatively for step five, apply many layers of NIR dye liquid composition having chemical resistance and/or mix with (a) visible dye and/or (b) UV dye. Then, dispose the epoxy layers as necessary. Finally, dispose the hard coat layers as necessary.

B. Polarized Lens or Flat Sheet

The process for manufacturing polarized curved lens or flat sheet can be separated into 2 parts. Part 1 relates to processes for the PVA film and part 2 relates to the processes for the lens substrate.

i. Part 1: PVA Film

Part 1 involves the manufacturing of PVA film. The processes for manufacturing PVA film can also be separated into two types: (a) with the use of primer and (b) without the use of primer.

The first method involves the use of primer. First, place the PVA film or flat PVA film on a holder. Then, spin to coat the primer. Next, then apply one or multiple layers of NIR dye liquid composition having chemical resistant and/or mix with (a) visible dye and/or (b) UV dye.

The second method for manufacturing PVA film is without the use of primer. After placing the PVA film and flat PVA film on a holder, apply one layer of NIR dye liquid composition having chemical resistant and/or mix with (a) visible dye and/or (b) UV dye. Alternatively, apply many layers of NIR dye liquid composition having chemical resistant layer and/or mix with visible dye and/or UV dye.

Then, dispose the epoxy layers as necessary.

ii. Part 2: Lens Substrate

Part 2 relates to the manufacturing processes for the lens substrate. First, inspect a lens substrate. Then, etch the lens substrate. Next, glue them together.

Using glue, combine the PVA film from part 1 and the lens substrate from part 2 together. Then, dispose spin hard coat on top side of the PVA film from part 1.

C. Polarized Curved Glass Lens or Flat Glass Lens.

The manufacturing processes for polarized curved glass lens or flat glass lens can be separated into 2 parts. Part 1 relates to processes for the PVA film and part 2 relates to the processes for the lens substrate.

i. Part 1: PVA Film

Part 1 involves the manufacturing of PVA film. The processes for manufacturing PVA film can also be separated into two types: (a) with the use of primer and (b) without the use of primer.

The first method involves the use of primer. First, place the PVA film or flat PVA film on a holder. Then, spin to coat the primer. Next, then apply one layer of NIR dye liquid composition having chemical resistant and/or mix with (a) visible dye and/or (b) UV dye. Alternatively, apply many layers of NIR dye liquid composition having chemical resistant layer and/or ix with visible dye and/or UV dye.

The second method for manufacturing PVA film is without the use of primer. After placing the PVA film and flat PVA film on a holder, apply one layer of NIR dye liquid composition having chemical resistant and/or mix with (a) visible dye and/or (b) UV dye. Alternatively, apply many layers of NIR dye liquid composition having chemical resistant layer and/or mix with visible dye and/or UV dye.

Then, dispose the epoxy layers.

ii. Part 2: Lens Substrate

Part 2 relates to the manufacturing processes for the lens substrate. First, apply glue to the bottom side of a glass lens or glass sheet to form part 2a. Then, apply glue to the top side of another lens or glass sheet to form part 2b. Then, glue 2a to the top of the PVA film from part 1 and glue 2b to the bottom the PVA film of part 1.

In another embodiment, the glass lens or glass sheet is coated with one or more layer through vacuum mirror coating or color mirror coating. Then, the convex side of the lens from part 2 is glued to the adhesive side of the PVA film from part 1. Finally, dispose the glue.

In yet another embodiment, the glass lens or glass sheet is coated with one or more layer through vacuum mirror coating or color mirror coating. Then, the concave side of the lens from part 2 is glued to the adhesive side of the PVA film from part 1. Finally, dispose the glue.

In yet another embodiment, the NIR liquid composition can be applied to the substrate through mold casting methods to be discussed in further detail next.

### DETAILED DESCRIPTION OF THE DRAWINGS

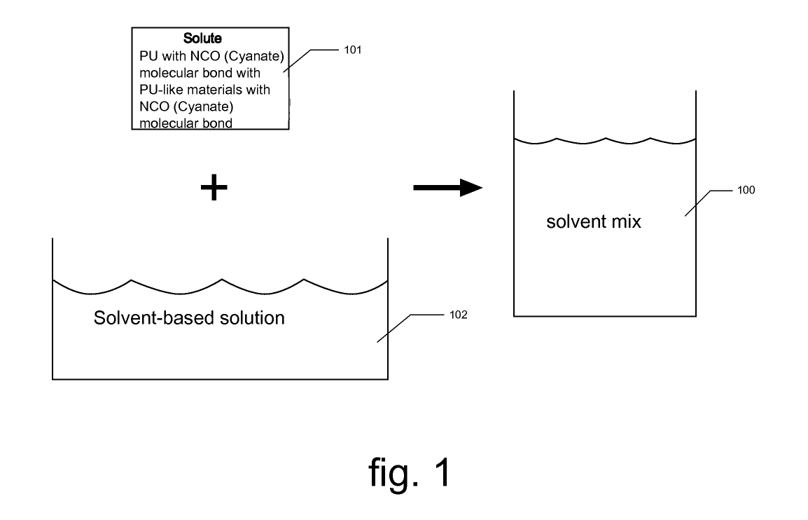

Referring to FIG. 1, the figure illustrates a preparation of the solute 101 Polyurethane (PU) containing polyisocyanate (or isocyanurate) having NCO (Cyanate) molecules and mixing it with solvent 102 to form a solvent mixture 103.

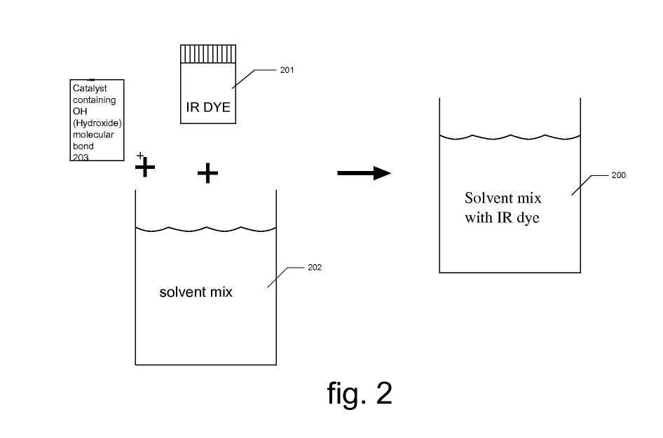

Next, referring to FIG. 2 is the preparation of the IR dye liquid solution 200, wherein the infrared dye 201 is dissolved into the previously prepared solution 202. More specifically, the IR dye absorb powder 201 can be dissolved in a solvent based solution with solid polymers such as acrylic, epoxy, PU, PVA, Polyurethane, etc. Thereafter, catalyst containing OH (Hydroxide) molecules 203 is added to the solvent mix 202 and form the IR dye liquid solution 200. Catalyst can be comprised of polyester polyol or hydroxyl-bearing polyacrylate.

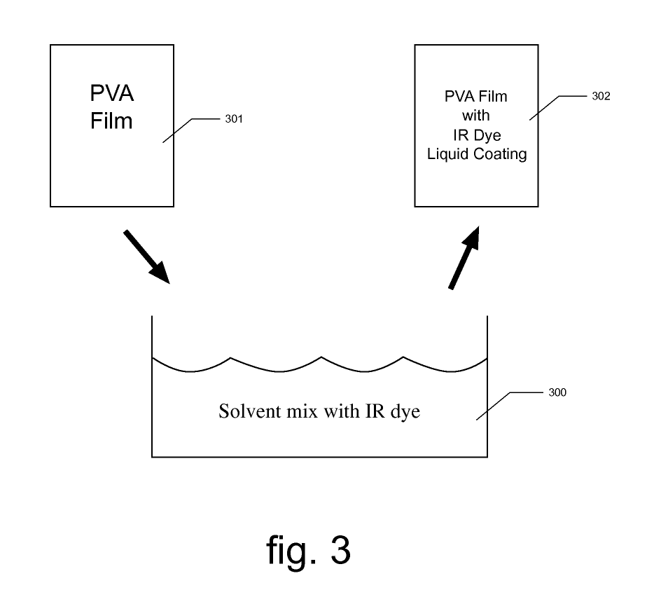

Referring to FIG. 3, which illustrates an application of the IR dye liquid 300 onto a PVA film 301 to form a PVA film with IR dye liquid coating 302. More specifically, the PVA film 301 is dipped into an IR dye liquid 300, wherein IR dye bonds with the PVA film 301 to form a PVA film with infrared dye liquid coating 302.

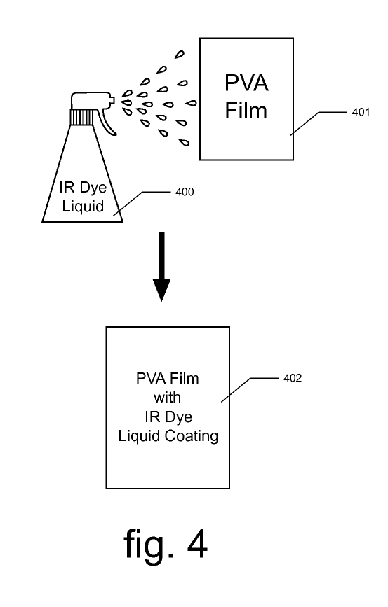

Referring to FIG. 4, which illustrates an alternative application of the water soluble infrared dye liquid 400 onto a PVA film 401 to form a PVA film with IR dye liquid coating 402. More specifically, the PVA film 401 is sprayed with infrared dye liquid solution 400, wherein the infrared dye bonds with the PVA film 401 to form a PVA film with infrared dye coating 402. Notably, the IR dye liquid can be coated through other various methods such as flowing, spinning, etc.

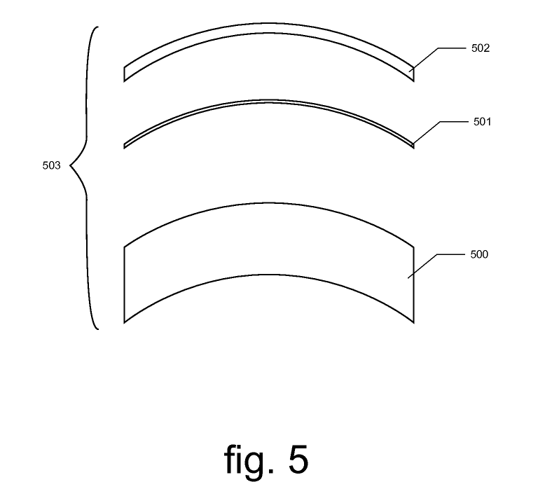

Referring to FIG. 5, which illustrates an application of a IR dye absorbed coating layer 501 onto a curved surface of a lens 503, wherein the lens 503 is made up of multiple layers 500, 501, 502, and one of the layers is the infrared dye absorbed coating 501 that is the result of the PVA film with IR dye liquid coating as depicted in FIG. 3 and FIG. 4.

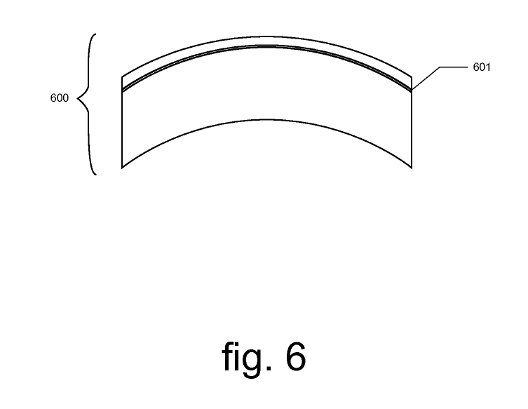

FIG. 6 illustrates a typical lens 600 comprises of layers including an outer, convex hard coating, a layer of hard epoxy, a PVA film with a infrared dye absorbed coating 601, a layer of hard epoxy, a PVA film, a layer of soft epoxy, a layer of adhesive, a base material and an inner concave hard coating.

### OTHER EMBODIMENTS OF NIR LAYERING METHODS

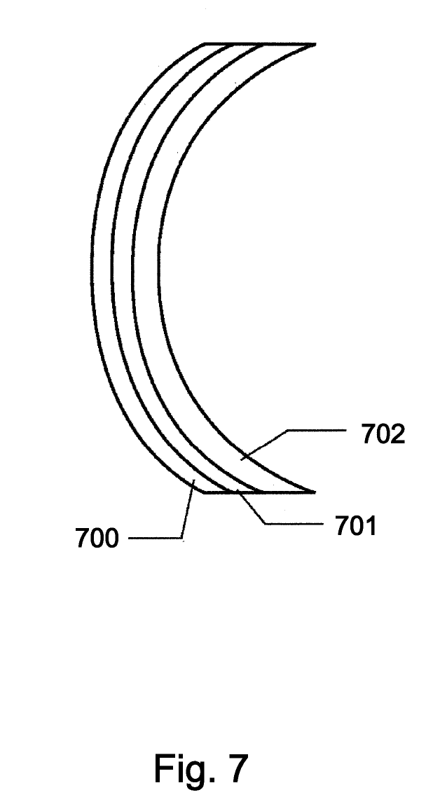

Referring to FIG. 7, which is a diagram of the casting method which there are four types to control the thickness of the substrate. Here, epoxy 700 is added to polarized film 701 and pre-formed substrate 722 (including but not limited to epoxy, PU, PC, AC, nylon, CR39).

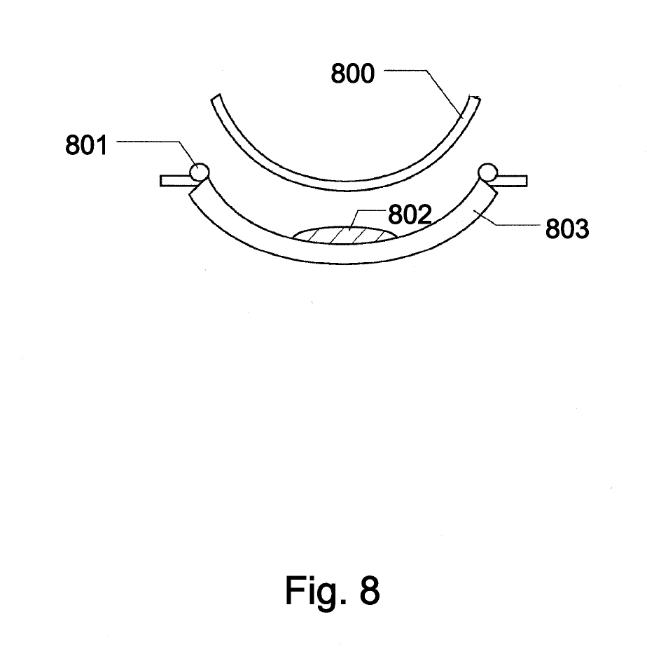

Referring to FIG. 8, which is a diagram of the O-ring controller for a mold, the circularly polarized film 800 is placed upon epoxy liquid 802 applied to the bottom mold 803. The O-ring 801 is constructed of PU (polyurethane) or silicon may be adjusted to control the thickness of the lens.

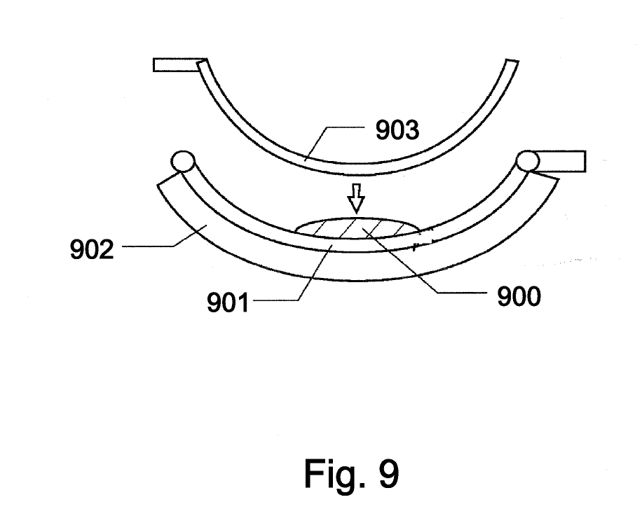

Referring to FIG. 9, which is a continuation of the above diagram, the top mold 903 is placed upon the circularly polarized film 900 which rests above a layer of epoxy 901 upon the bottom mold 902.

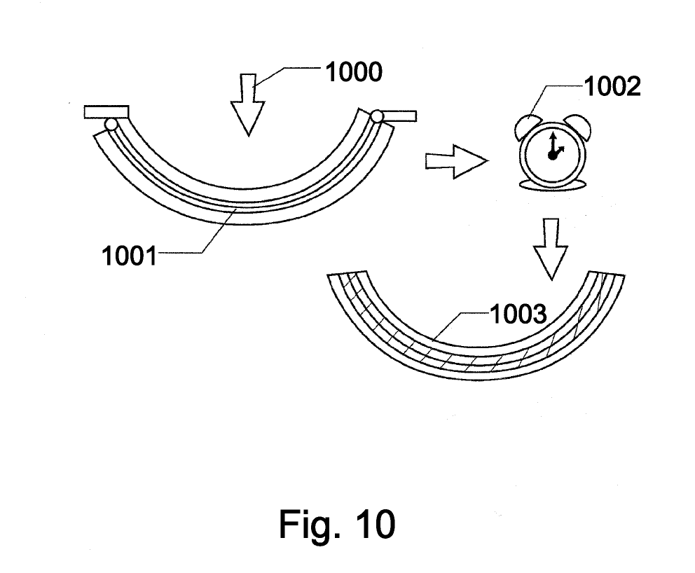

Referring now to FIG. 10, which is a continuation of the sequential steps of the above diagram, 1000 the molds are pressed together in order to shape the circularly polarized lens 1001. A waiting period 1002 occurs, during which the curing process occurs. The mold may be removed after 10-30 hours. After 30-72 hours, the lens will be fully set and the finished product 1003 is hardened and removed.

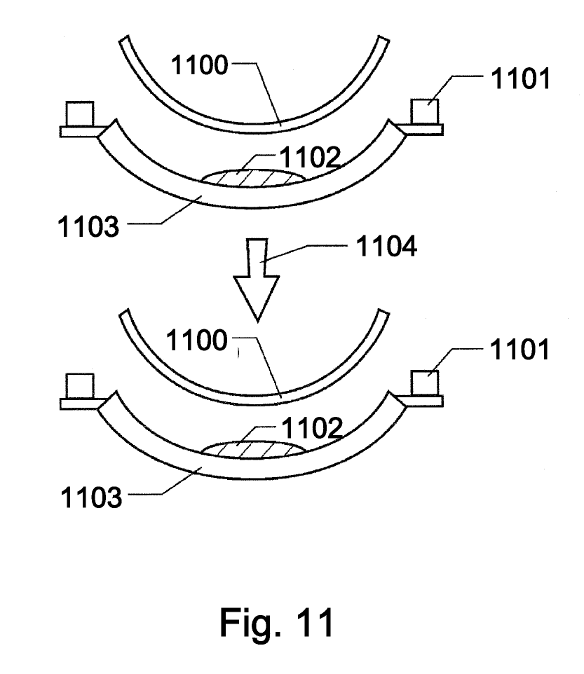

Referring to FIG. 11, which is a diagram of the supporter, the circularly polarized lens 1100 is placed upon a layer of epoxy liquid 1102 on top of the bottom mold 1103. A leg 1101 on either end of the mold lends support in the vertical direction. In the following step 1104, the circular polarized layer 1100 is placed upon the readied mold.

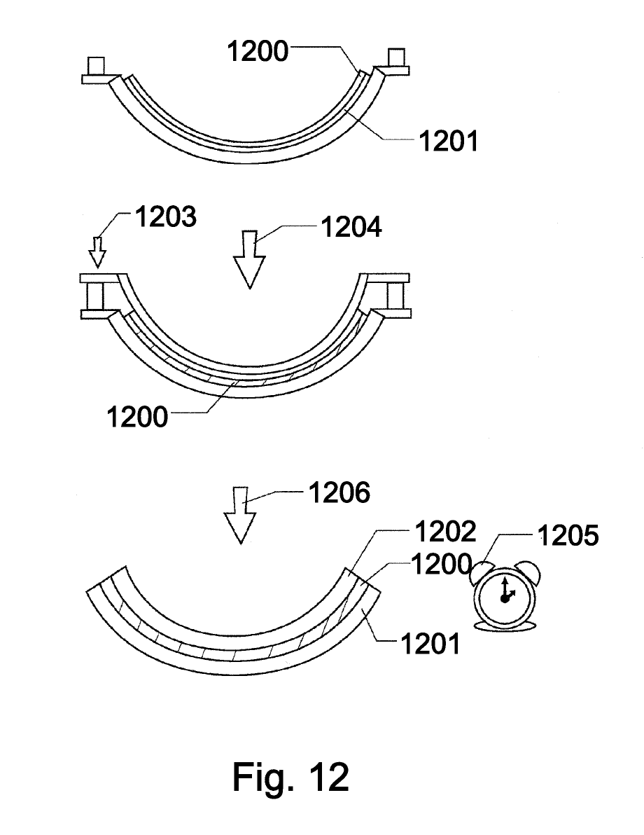

Referring to FIG. 12, which is a diagram of the next step of the procedure involving the supporter, the polarized layer 1200 has been placed atop the epoxy layer 1201 on the mold. In the following step 1204, the two molds are pressed together with the polarized layer 1200 sandwiched in between. Then, in the next step 318, the polarized layer is sandwiched between two layers of epoxy 1202. A waiting period of 10-30 hours commences 1205. The curing process occurs and the mold may then be removed. The lens will then be fully set.

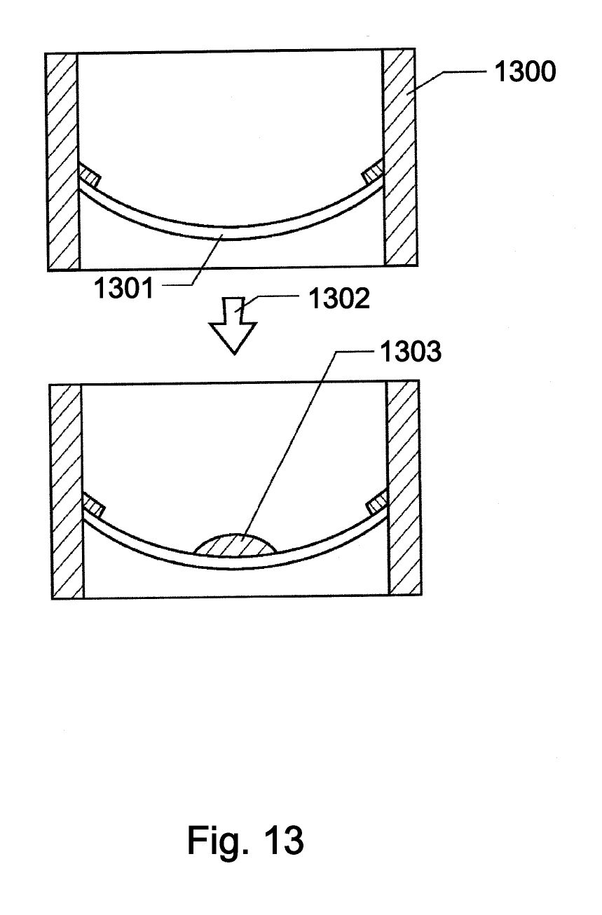

Referring to FIG. 13, which is a diagram of procedural steps in the rim-lock method with epoxy drops, a rim-lock 1300 is attached on either side of a bottom glass mold 1301. In the following step 1302, epoxy 1303 is added on top of the glass mold.

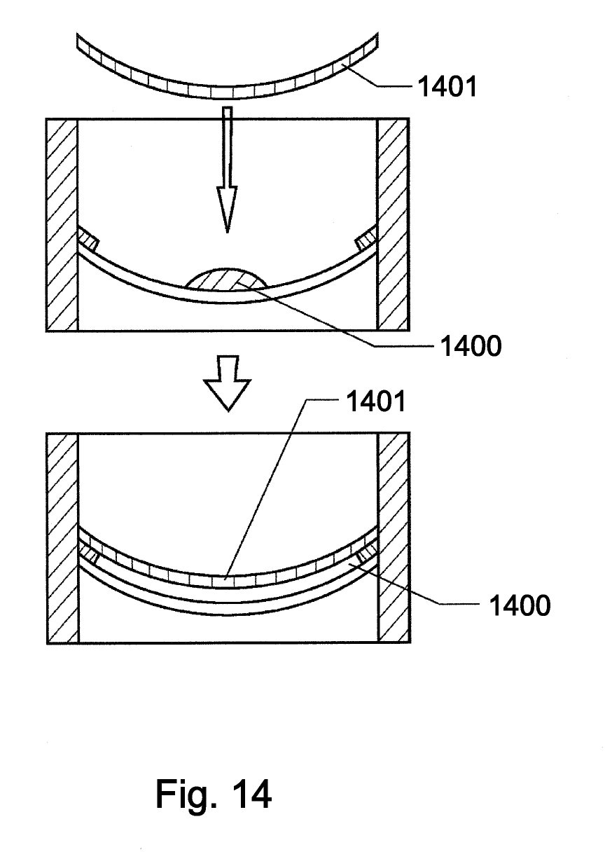

Referring now to FIG. 14, which is a diagram of the next step of the rim-lock method, a curved circularly polarized layer 1401 is added on top of the epoxy 1400.

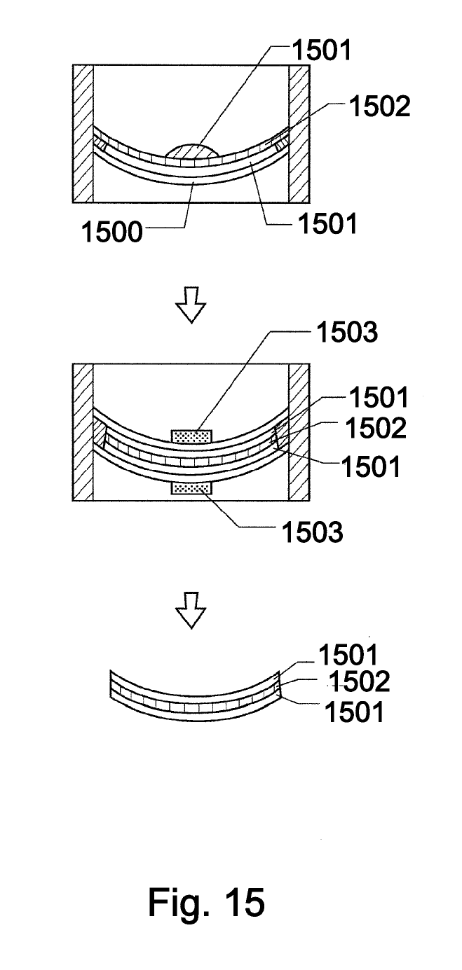

Referring now to FIG. 15, which is a diagram of the next step of the rim-lock method, an upper glass mold 1500 is pressed downwards upon an additional layer of epoxy 1501 over the circularly polarized layer 1502. In the following step, clippers 1503 are used to secure the combined layers together firmly. The layers now include a circularly polarized layer 1502 sandwiched in between layers of epoxy 1501. Following a waiting period of 48 hours, the finished product is removed from the mold and includes a cured circularly polarized layer 1502 sandwiched between layers of epoxy 1501.

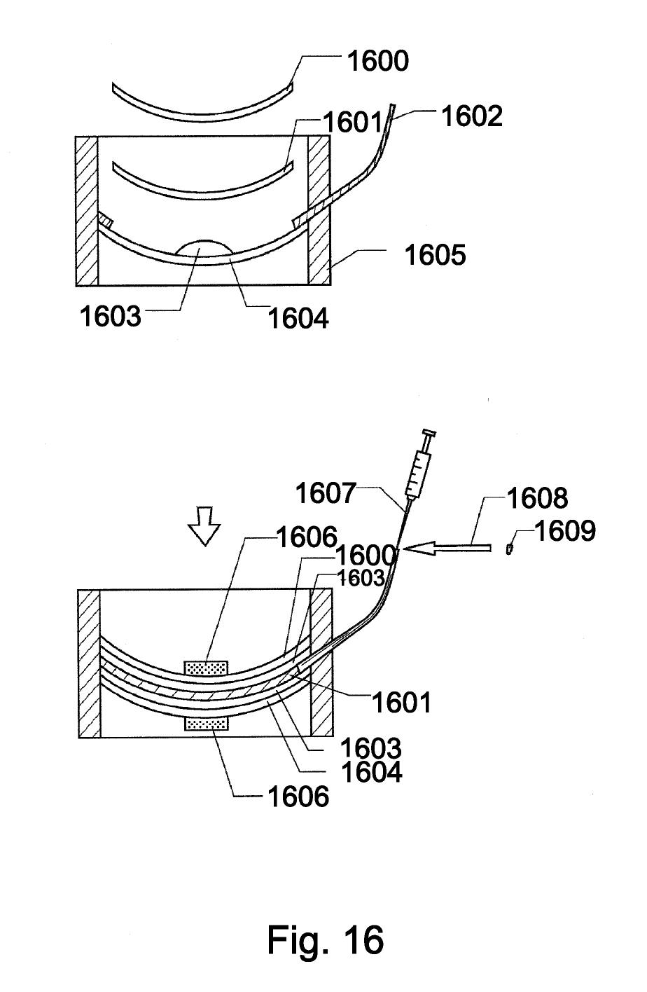

Referring now to FIG. 16, which is the rim-lock method with epoxy injection procedural diagram, a rim lock 1605 is attached to either side of a bottom glass mold 1604. Epoxy 1603 is introduced into the system above the bottom mold 1604 via an epoxy injection tube 1602. Then, a circularly polarized layer 1601 is placed upon the epoxy 1603, and a top glass mold 1600 is pressed down upon the entire combination of layers. In the following sequential diagram, a clamp 1606 secures the combination of layers, which now include the top mold 1600, two layers of epoxy 1603 surrounding a circularly polarized layer 1601, and a bottom mold 1604. The epoxy was injected into the system via a dropper or syringe-like device 1607 in the preceding step 1608. A cap 1609 plugs the epoxy injection port after epoxy injection.

### EXAMPLES OF LAYERED IR ABSORBING LENS

### Example 1

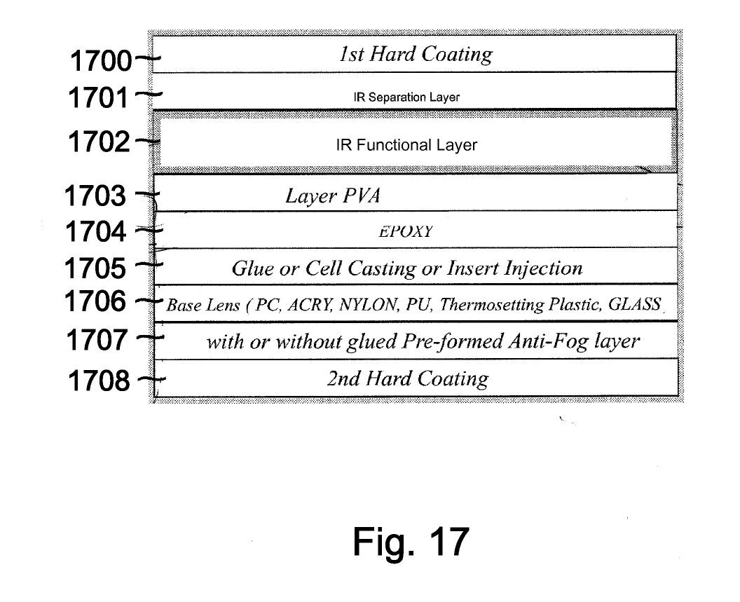

Referring now to FIG. 17, which discloses a cross-sectional view of a layered lens produced by the claimed methods where the convex surface of the first hard coating 1700 is the surface furthest away from the eyes of the wearer and the concave surface of the second hard coating 1708 is the surface closest surface to the eyes of the wearer. In one embodiment of the present invention, as disclosed in FIG. 17 of the present application, the IR lens are made of the following layers: a first hard coating 1700, an IR isolation layer 1701, an IR functional layer 1702, aPVA layer 1703, the epoxy layer 1704, glue or cell casting or insert injection 1705, base lens (PC, ACRY, NYLON, PU, Thermosetting plastic, Glass) 1706, with or without glued pre-formed anti-fog layer 1707, and a second hard coating 1708.

### Example 2

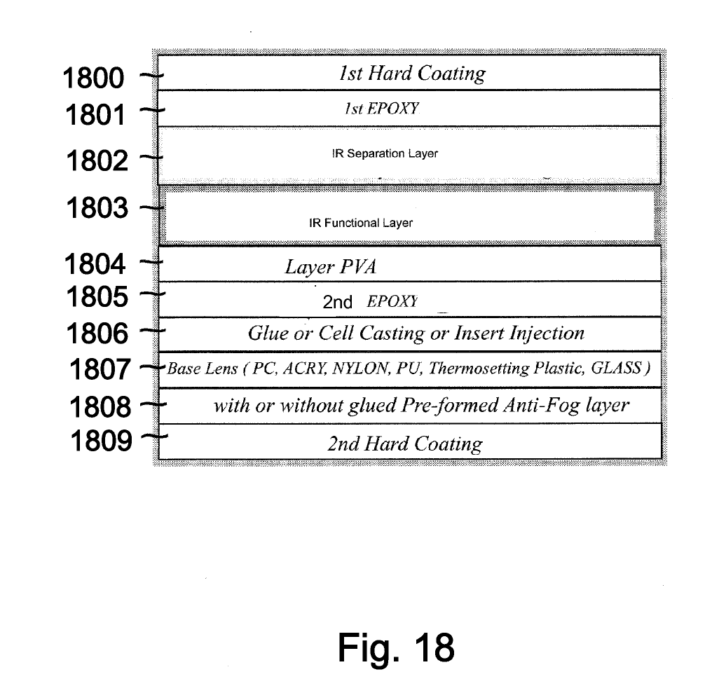

Referring now to FIG. 18, which disclose a cross-sectional view of a layered lens produced by the claimed methods where the convex surface of the first hard coating 1800 is the surface furthest away from the eyes of the wearer and the concave surface of the second hard coating 1809 is the surface closest surface to the eyes of the wearer. In one embodiment of the present invention, as disclosed in FIG. 18 of the present application, the IR lens are made of the following layers: a first hard coating 1800, a 1st epoxy layer 1801, an IR isolation layer, an IR functional layer 1803, a PVA layer 1804, a second epoxy layer 1805, glue or cell casting or insert injection 1806, base lens (PC, ACRY, NYLON, PU, Thermosetting plastic, Glass) 1807, with or without glued pre-formed anti-fog layer 1808, and a second hard coating 1809.

### Example 3

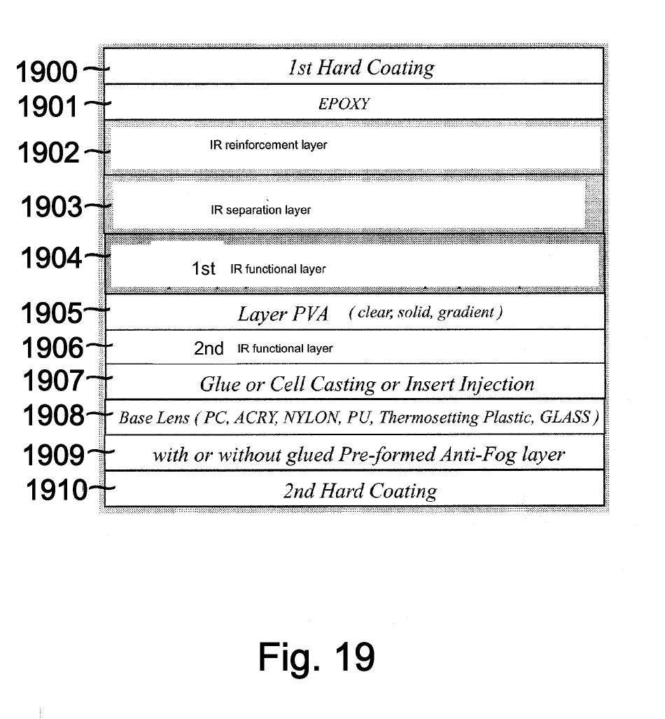

Referring now to FIG. 19, which disclose a cross-sectional view of a layered lens produced by the claimed methods where the convex surface of the first hard coating 1900 is the surface furthest away from the eyes of the wearer and the concave surface of the second hard coating 1910 is the surface closest surface to the eyes of the wearer. In one embodiment of the present invention, as disclosed in FIG. 19 of the present application, the IR lens is made up of the following layers: a first hard coating 1900, an epoxy layer 1901, an IR reinforcement layer 1902, and IR isolation layer 1903, a first IR functional layer, a PVA layer 1905, a second IR functional layer 1906, glue or cell casting or insert injection 1907, base lens (PC, ACRY, NYLON, PU, Thermosetting plastic, Glass) 1908, with or without glued pre-formed anti-fog layer 1909, and a second hard coating 1910.

### Example 4

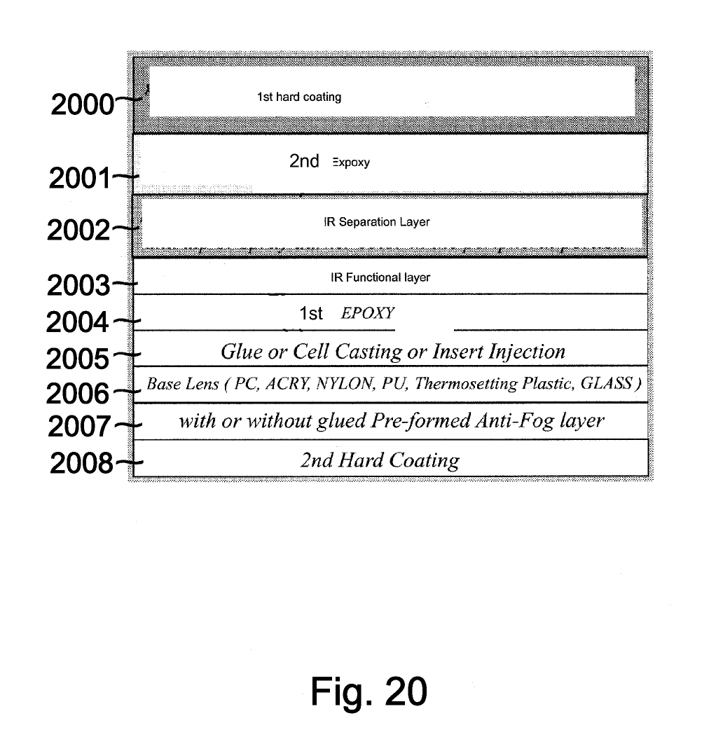

Referring now to FIG. 20, which disclose a cross-sectional view of a layered lens produced by the claimed methods where the convex surface of the first hard coating 2000 is the surface furthest away from the eyes of the wearer and the concave surface of the second hard coating 2008 is the surface closest surface to the eyes of the wearer. In one embodiment of the present invention, as disclosed in FIG. 20 of the present application, the IR lens are made up of the following layers: a first hard coating 2000, a second epoxy layer 2001, an IR isolation layer 2002, an IR functional layer 2003, a first epoxy layer, glue or cell casting or insert injection 2005, base lens (PC, ACRY, NYLON, PU, Thermosetting plastic, Glass) 2006, with or without glued pre-formed anti-fog layer 2007, and a second hard coating 2008.

1. A method to manufacture infrared lens comprising the steps of:
a. providing a portion of polyurethane (PU) material wherein said portion of polyurethane (PU) material is comprised of NCO compound;
b. providing a portion of IR dye and mixing said IR dye to said portion of polyurethane (PU) material to form a portion of IR PU solution;
c. mixing a portion of catalyst wherein said catalyst is comprised of OH compound with said IR PU solution to form a portion of OH IR PU material;
d. providing a portion of solvent and mixing said OH IR PU material to said solvent to form a portion of OH IR PU liquid solution;
e. applying said OH IR PU liquid solution to a lens layer;
f. allowing said OH IR PU liquid solution to solidify to form a IR functional lens layer.

2. The method of claim 1 wherein said portion of polyurethane (PU) material is comprised of isocyanurate or polyisocyanate.

3. The method of claim 1 further comprising the step of allowing said OH IR PU liquid solution to solidify between 4-8 hours.

4. The method of claim 1 further comprising the step of allowing said OH IR PU liquid solution to solidify for 6 hours.

5. The method of claim 1 wherein the ratio of said portion of solvent to said portion of polyurethane (PU) material is 2:1.

6. The method of claim 1 wherein said portion of IR dye is between 1-3% of said portion of IR PU solution.

7. The method of claim 1 wherein said catalyst is selected from a group consisting of polyester polyol or hydroxyl-bearing polyacrylate.

8. The method of claim 1 wherein the ratio of said NCO compound to said OH compound is between 1:0.3 to 1:16.

9. The method of claim 1 wherein the ratio of said NCO compound to said OH compound is 1:5.

10. The method of claim 1 wherein said IR functional lens layer is between 0.03-0.12 mm in thickness.

11. The method of claim 1 wherein said solvent is selected from a group consisting of Tetrakis ammonium structure, Iminium phthalocyanines, naphthalocyanines, metal complexes, azo dyes, anthraquinones, quadratic acid derivatives, immonium dyes, perylenes Dianthrones Cyanines Heteroaromatics Metal Dithiolenes Oxadiazoles Phthalocyanines Spiropyra Tetraaryldiamines Triarylamines,

12. The method of claim 1 further comprising the step of applying a layer of isolation layer between said IR functional layer to said lens layer.

13. The method of claim 10 wherein said isolation layer is selected from a group consisting of PU, acrylic, silicon and epoxy compounds.

14. The method of claim 10 wherein said isolation layer is comprised of PU, acrylic, silicon and epoxy compounds.

15. The method of claim 1 furthering comprising the step of applying a reinforcement layer between said IR functional lens layer and said lens layer.

16. The method of claim 15 further comprising the step of applying a reinforcement layer between said IR functional lens layer and said IR isolation layer.

17. The method of claim 1 wherein said reinforcement layer is comprised of epoxy compound wherein said epoxy compound further comprises acrylic resin.

18. An infrared absorbing lens apparatus comprising:
a. a base substrate;
b. a IR functional lens layer wherein said IR functional lens layer comprises a portion of PU wherein said portion of PU further comprising a portion of NCO compound, a portion of IR dye, and a portion of catalyst wherein said catalyst further comprising a portion of OH compound.

19. The apparatus of claim 18 wherein said apparatus further comprising a PVA film layer.

20. The apparatus of claim 18 wherein said apparatus further comprising an epoxy layer.

21. The apparatus of claim 18 wherein said apparatus further comprising a hard coating layer.

22. The apparatus of claim 18 wherein said apparatus further comprising a isolation layer.

23. The apparatus of claim 18 wherein said apparatus further comprising a reinforcement layer.

24. The apparatus of claim 20 wherein said reinforcement layer is comprised of PU, acrylic, silicon and epoxy compounds

25. A method to manufacture infra red absorbing lens comprising:
a. providing a portion of silicon material;
b. providing a portion of solvent and mixing said portion of solvent to said portion of silicon material to form a portion of silicon solution;
c. providing a portion of IR dye and mixing said portion of IR dye to said portion silicon solution to form a portion of IR silicon solution;
d. providing a portion of acid to said portion of IR silicon solution to form a portion of acid IR silicon solution;
e. applying said portion of acid IR silicon solution to a lens layer;
f. heating said acid IR silicon solution to allowing said acid IR silicon solution to solidify to form a IR functional lens layer.

26. The method of 25 wherein the ratio of said portion of acid to said portion of IR silicon solution is 1 to 500.

27. The method of 25 further comprising heating said portion of acid IR silicon solution to 85-100 degree Celsius.

28. The method of 25 further comprising heating said portion of IR silicon solution for 1-3 hours.

29. The method of 25 wherein the thickness of said IR functional lens layer is between 0.03-0.12 mm.

30. The method of 25 wherein said solvent is selected from a group consisting of Tetrakis ammonium structure, Iminium phthalocyanines, naphthalocyanines, metal complexes, azo dyes, anthraquinones, quadratic acid derivatives, immonium dyes, perylenes Dianthrones Cyanines Heteroaromatics Metal Dithiolenes Oxadiazoles Phthalocyanines Spiropyra Tetraaryldiamines Triarylamines.

31. The method of 25 further comprising applying a layer of isolation layer between said IR functional lens layer to said lens layer.

32. The method of 23 wherein said isolation layer is comprised of PU, acrylic, silicon, epoxy or similar material.

33. The method of 25 furthering applying a reinforcement layer between said IR functional lens layer and said lens layer.

34. The method of 25 wherein said reinforcement layer is comprised of an epoxy compound wherein said epoxy ground comprises acrylic resin.

35. An IR lens apparatus comprising:
a. a first layer of hard coating comprising a first surface and a second surface wherein said first surface of said first layer of hard coating is furthest away from a user;
b. a second layer of hard coating comprising a first surface and a second surface wherein said 2nd hard coating second surface is closest to said user;
c. a layer of IR isolation layer having a first surface and a second surface where said first surface of IR isolation layer is adjacent to said second surface of said first coating layer;
d. an IR functional layer having a first surface and a second surface wherein said functional layer first surface is adjacent to said second surface of said IR isolation layer;
e. a layer of PVA film comprising a first surface and a second surface wherein said first surface of said PVA film layer adjacent to said second surface of said IR functional layer;
f. a layer of epoxy comprising a first surface and a second surface wherein said first surface of said epoxy layer is adjacent to said second surface of PVA film layer;
g. a base lens layer comprising a first surface and a second surface wherein said first surface of said base lens layer adjacent to said second surface of said epoxy layer; and
h. said first surface of said second hard coating is adjacent to said second surface of said base lens layer.

36. An IR lens apparatus comprising:
a. a first layer of hard coating comprising a first surface and a second surface wherein said first surface of said first layer of hard coating is furthest away from a user;
b. a second layer of hard coating comprising a first surface and a second surface wherein said 2nd hard coating second surface is closest to said user;
c. a first layer of epoxy comprising a first surface and a second surface wherein said first surface of said first layer of epoxy is adjacent to said second surface of said first layer of coating;
d. a layer of IR isolation layer having a first surface and a second surface where said first surface of IR isolation layer is adjacent to said second surface of said first epoxy layer;
e. an IR functional layer having a first surface and a second surface wherein said functional layer first surface is adjacent to said second surface of said IR isolation layer;
f. a layer of PVA film comprising a first surface and a second surface wherein said first surface of said PVA film layer adjacent to said second surface of said IR functional layer;
g. a layer of second epoxy comprising a first surface and a second surface wherein said first surface of said second epoxy layer is adjacent to said second surface of PVA film layer;
h. a base lens layer comprising a first surface and a second surface wherein said first surface of said base lens layer adjacent to said second surface of said epoxy layer; and
i. said first surface of said second hard coating is adjacent to said second surface of said base lens layer.

37. An IR lens apparatus comprising:
a. a first layer of hard coating comprising a first surface and a second surface wherein said first surface of said first layer of hard coating is furthest away from a user;
b. a second layer of hard coating comprising a first surface and a second surface wherein said 2nd hard coating second surface is closest to said user;
c. a layer of epoxy comprising a first surface and a second surface wherein said first surface of said layer of epoxy is adjacent to said second surface of said first layer of coating;
d. a layer of IR reinforcement layer having a first surface and a second surface where said first surface of IR reinforcement layer is adjacent to said second surface of said epoxy layer;
e. a layer of IR isolation layer having a first surface and a second surface where said first surface of IR isolation layer is adjacent to said second surface of said reinforcement layer;
f. a first IR functional layer having a first surface and a second surface wherein said first functional layer first surface is adjacent to said second surface of said IR isolation layer;
g. a layer of PVA film comprising a first surface and a second surface wherein said first surface of said PVA film layer adjacent to said second surface of said IR functional layer;
h. a layer of second IR functional layer comprising a first surface and a second surface wherein said first surface of said second IR functional layer is adjacent to said second surface of said PVA film layer;
i. a base lens layer comprising a first surface and a second surface wherein said first surface of said base lens layer adjacent to said second surface of said epoxy layer; and
j. said first surface of said second hard coating is adjacent to said second surface of said base lens layer.

36. An IR lens apparatus comprising:
a. a first layer of hard coating comprising a first surface and a second surface wherein said first surface of said first layer of hard coating is furthest away from a user;
b. a second layer of hard coating comprising a first surface and a second surface wherein said 2nd hard coating second surface is closest to said user;
c. a layer of first epoxy comprising a first surface and a second surface wherein said first surface of said layer of first epoxy is adjacent to said second surface of said first layer of coating;
d. a layer of IR isolation layer having a first surface and a second surface where said first surface of IR isolation layer is adjacent to said second surface of said first epoxy layer;
e. a first IR functional layer having a first surface and a second surface wherein said first functional layer first surface is adjacent to said second surface of said IR isolation layer;
f. a layer of second epoxy comprising a first surface and a second surface wherein said first surface of said second epoxy layer adjacent to said second surface of said IR functional layer;
g. a base lens layer comprising a first surface and a second surface wherein said first surface of said base lens layer adjacent to said second surface of said second epoxy layer; and
h. said first surface of said second hard coating is adjacent to said second surface of said base lens layer.
